(19) United States
(12) Patent Application Publication
(10) Pub. No.: US 2009/0199356 A1
(43) Pub. Date: Aug. 13, 2009

(54) Linear or disk brush material, cylindrical brush, and method of manufacturing the linear or disk brush material

(75) Inventor: Terumasa Aoki, Tokyo (JP)

Correspondence Address: BUCHANAN, INGERSOLL & ROONEY PC, POST OFFICE BOX 1404, ALEXANDRIA, VA, 22313-1404, US

(73) Assignee: AOKI SWEEPER CO., LTD., Katsushika-ku (JP)

(21) Appl. No.: 12/073,708

(22) Filed: Mar. 7, 2008

(30) Foreign Application Priority Data
Feb. 13, 2008 (JP) 2008-31273

(51) Int. Cl. A46B 13/00; A46D 1/00; B23P 17/00

(52) U.S. Cl. 15/179; 15/207.2; 29/527.1

(57) ABSTRACT

A linear or disk steel brush material for a rotary brush in which the root portions of a large number of steel brush wires are inserted and fixed into a linear or ring-like steel channel having a U-shaped cross section and an opening directed to an outer peripheral side, wherein the root portions of the steel brush wires are fixed by synthetic resin to obtain a solid portion, the solid portion is fitted into the steel channel and is then latched and fixed to a latching section projected inward from the steel channel wall, and both opening edge portions of the steel channel are curved outward.

### BACKGROUND OF THE INVENTION

1. Field of the Invention

The present invention relates to a linear or disk brush material, a cylindrical brush, and a method of manufacturing the linear or disk brush material.

2. Prior Art

A cleaning brush of a cleaning device which is driven by power, as illustrated in FIG. 18, has hitherto been manufactured as follows. A large number of synthetic resin wires 48 are bent and inserted into a metal channel 46 via a metal wire 47. The metal channel 46 is pressed and deformed to the outside if the synthetic resin wires 48 and the metal wire 47. The synthetic resin wires 48 and the metal wire 47 are sandwiched and fixed by the metal channel 46. The metal channel 46 is, for example, made of steel.

In this way, the brush has included the metal channel, the synthetic resin wires, and the metal wire. The metal and the synthetic resin of the brush have been disposal-recycled, respectively, by separating the metal channel and the synthetic resin wires, and then, the metal wire.

Typically, an attached portion is manufactured in annular shape as a circular shape and is than fitted into t shaft, thereby manufacturing a roll brush or a disk brush. The coarseness and fineness of the roll brush are determined according to the coarseness and fineness of fibers in a brush material. Alternatively, the coarseness and fineness of the roll brush having brush materials at the same density are determined according to the fitting density of annular brush materials. A spacer is interposed between the annular brush materials to determine the coarseness and fineness according to thickness.

A ring-like or tubular steel brush has hitherto been used for snow removal, water draining, or cleaning.

A method of manufacturing the steel brush is disclosed as follows. A ring-like steel channel which has a U-shaped steel cross section and an opening directed to an outer peripheral side is prepared. Steel brush wires molded in wavy shape are folded into two. A core wire is interposed in the two-folded portion. The steel brush wires are inserted into the opening of the steel channel. The steel channel is caulked to fix the steel brush wires and the steel channel (Japanese Patent Application Publication No. 1-33311).

This adopts a structure in which the root portion of a brush unit is fixed to the peripheral edge portion of a polygonal substrate. Annular brushes are manufactured and are then arranged in parallel to obtain a roll brush. The manufacturing process becomes complicated.

There has been known a rotary brush in which the root portion of a brush body is fixed to a rod-like body and the rod-like body is fixed to the outer peripheral portion of a retaining plate (WO1998/09551).

This describes a cloth brush and a hair brush mainly for an electrostatic process. In an embodiment in which the hair brush is helically wound, its integration is not intended and merely a fixing state is not shown.

Japanese Patent Application Laid-Open No. 3464999 discloses a brush in which two plastic channels bent in trapezoidal shape to which fiber ends are fixed are overlapped with each other and bent to obtain an annular brush material, and the annular brush material is fitted into a shaft.

Japanese Patent Application Laid-Open No. 2001-17376 proposes a rotary brush. The rotary brush has a brush body buried into a rod-like body. When the rotary brush is used for a heavy cleaning work such is snow removal, water draining, or metal surface cleaning, the brush body of the rod-like body can be loosened or fall off. Even if the root portion of the brush body is tightened by an opening edge of the rod-like body, the brush body can be loosened and fall off and can be easily folding-damaged. The rotary brush is unsuitable for the heavy cleaning work.

Japanese Patent Application Laid-Open No. 2004-195171 proposes a structure in which steel brush wires are folded into two and are then inserted into a channel and a core wire is interposed in the center portion of the steel brush wires. In the related art, one core wire is unstable. When the brush material is spirally wound around a shaft, a force to tie the steel brush wires to the steel channel is weak with one core wire. The steel brush wires are loosened or fall off. Repeating vibration of the brush can folding-damage the core wire. When the number of core wires is increased (e.g., three or four), the total weight is increased due to the core retires.

The brush which has been used includes the metal channel, the synthetic resin fibers, and the metal wire. Fixing by heating and fusion-bonding, has not been conceivable. In the brush which has been used, the manufacturing process becomes complicated and the metal and the synthetic resin need to be Separated for the recycling process.

Any of the techniques which have been known is based on the annular brush material. There are many problems of increase in efficiency of manufacture, improvement in strength, and adjustment of a brush density.

### SUMMARY OF THE INVENTION

An object of the present invention is to address these problems.

According to the present invention, an appropriate number of synthetic resin fibers can be inserted into a continuous synthetic resin channel and then be easily and reliably fixed by pressing and beating.

The synthetic resin channel can be extruded and molded in endless manner. Therefore, the brush material according to the present invention can be continuously formed in endless manner. When the brush material is cut to an appropriate length, one to a plurality of annular brush materials can be freely selected as a unit brush material. The plurality of annular brushes are integrally tubular-shaped by fusion-bonding the channels to each other, thereby reinforcing strength.

If the coarseness and fineness of fibers of one annular brush material and a plurality of (e.g., two to six) annular brush materials are optionally created, a roll brush whose partial coarseness and fineness are freely selected can be manufactured.

According to the present invention, the steel brush wires or the synthetic resin wires for a brush are linearly arranged and stacked to a fixed thickness, their root portions are subjected to a synthetic resin process and integrated so as to obtain a solid portion in which, in appearance, the steel brush wires are buried into the synthetic resin substrate. The solid portion solidified by the synthetic resin is inserted into a steel channel or a synthetic resin channel having a U-shaped cross section. The steel channel or the synthetic resin channel is pressed. A latching section is formed inwardly of the steel channel and is then pressed and latched to the solid portion solidified by the synthetic resin. The steel brush wires and the steel channel are reliably latched and fixed, thereby addressing the above problems. The steel brush wires and the synthetic resin channel are reliably integrated, thereby addressing the above problems.

An opening of the steel channel is curved outward in arcuate shape to reduce the local concentration of an abutting force of the channel and the steel brush wires. The force of the abutting portions of the steel brush wires and the steel channel is released. The folding-damage of the steel brush wires can be prevented.

The brush material and the brush according to the present invention are preferable as a brush for a heavy cleaning work. The term “heavy cleaning work” is referred to as a work with high rotation at 700 rpm or more, a work with a large grounding width of 200 mm or more, and a work at a cleaning speed of 40 km or more per hour, or a combination of these works.

A cleaning work which uses the brush material and the brush for straight running and rotational running, has the amount of objects to be removed is large, and is continued for a long time at −20° C. or less is called the heavy cleaning work.

The present invention is as follows.

Claim 1: A linear or disk steel brush material for a rotary brush in which the root portions of a large number of steel brush wires are inserted and fixed into a linear or ring-like steel channel having a U-shaped cross section and an opening directed to an outer peripheral side, wherein the root portions of the steel brush wires are fixed by synthetic resin to obtain a solid portion, the solid portion is fitted into the steel channel and is then latched and fixed to a latching section projected inward from the steel channel wall, and both opening edge portions of the steel channel are curved outward.

Claim 2: A linear or disk steel brush material for a rotary brush in which the root portions of a large number of steel brush wires are inserted and fixed into a linear or ring-like steel channel having a U-shaped cross section and an opening directed to an outer peripheral side, wherein the root portions of the steel brush wires are fixed by synthetic resin to obtain a solid portion, the solid portion is fitted into the steel channel and is then latched and fixed to a latching section projected inward from the steel channel wall, a synthetic resin solidification agent is applied to near the steel channel of the steel brush wires, and both opening edge portions of the steel channel are curved outward.

Claim 3: A linear or disk brush material wherein the insertion portions of synthetic resin wires for a brush are solidified by an adhesive or heating and fusion-bonding to obtain a solid portion, and the solid portion of the synthetic resin wires for a brush is inserted and fixed into a linear or ring-like synthetic resin channel having a U-shaped cross section so as to integrate the synthetic resin channel and the insertion portions of the synthetic resin wires for a brush.

Claim 4: A linear or disk brush material wherein the insertion portions of synthetic resin wires for a brush are solidified by an adhesive or heating and fusion-bonding to obtain a solid portion, the solid portion of the synthetic resin wires for a brush is inserted into a linear or ring-like steel channel having a U-shaped cross section, and a latching section obtained by pressing and stamping the side portion of the steel channel is pressed and latched to the solidified solid portion.

Claim 5: A linear or disk brush material wherein the insertion portions of synthetic resin wires for a brush are solidified by an adhesive or heating and fusion-bonding to obtain a solid portion, the solid portion of the synthetic resin wires for a brush is inserted and fixed into a linear or ring-like synthetic resin channel having a U-shaped cross section so as to integrate the synthetic resin channel and the insertion portions of the synthetic resin wires for a brush, and a steel channel is fitted to the outside of the synthetic resin channel to integrate both the channels.

Claim 6: A linear or disk brush material wherein the insertion portions of synthetic resin wires for a brush are solidified by an adhesive or heating and fusion-bonding to obtain a solid portion, the solid portion of the synthetic resin wires for a brush is inserted and fixed into a linear or ring-like synthetic resin channel having a U-shaped cross section so as to integrate the synthetic resin channel and the insertion portions of the synthetic resin wires for a brush, a steel channel is fitted to the outside of the synthetic resin channel, and a latching section projected on the side wall of the steel channel is pressed and latched to the synthetic resin channel to integrate both the channels.

Claim 7: A brush material wherein a fixed number of end portions of synthetic resin fibers or wires are continuously or intermittently inserted into a synthetic resin channel and are then fixed thereinto by heating and pressing.

Claim 8: A brush wherein the brush material according to claim 7 is formed in linear, spiral, or annular shape and is then fixed into a shaft.

Claim 9: A brush wherein a predetermined number of the spiral brush materials according to claim 8 are fitted and fixed into a rotating shaft and are then integrated therewith to obtain a roll brush.

Claim 10: The brush according to claim 9, wherein stepped portions on both sides of the roll brush and projections of disks fitted to the rotating shaft are abutted to confine the roll brush in a rotating direction.

Claim 11: A brush wherein one or a plurality of annular brush materials are fixed into one end portion of a shaft to obtain a disk brush.

Claim 12: A brush wherein a predetermined number of the linear brush materials formed according to claim 8 are arranged in parallel, bonded, and fixed so as to be in box shape.

Claim 13: A brush wherein a predetermined number of the linear brush materials formed according to claim 8 are manufactured so as to be linear or deformed.

Claim 14: A cylindrical steel brush wherein a plurality of the disk steel brush materials using the ring-like steel channel according to claim 1 or 2 are fitted into a rotating shaft, and are abutted and fixed or are fixed at predetermined intervals.

Claim 15: A tubular steel brush wherein a plurality of the linear steel brush materials according to claim 1 or 2 are supported so as to be parallel with a rotating shaft at equally spaced intervals on a concentric circumference about the rotating shaft.

Claim 16: A cylindrical brush wherein a plurality of the disk brush materials according to claim 3 or 4 are fitted into a rotating shaft, and are abutted and fixed or are fixed at predetermined intervals.

Claim 17: A tubular brush wherein a plurality of the linear brush materials according to claim 3 or 4 are supported so as to be parallel with a rotating shaft at equally spaced intervals on a concentric circumference about the rotating shaft.

Claim 18: A method of manufacturing a linear or disk steel brush material wherein a large number of steel brush wires of the same length are linearly arranged at a predetermined thickness, molten synthetic resin is applied to and penetrated into the root portion side of the steel brush wires and is then cooled and solidified to provide a solid portion in the steel brush wires for obtaining a steel brush wire band, the solid portion side of the steel brush wire band is inserted and fixed into a linear or ring-like steel channel which is separately manufactured and opened outward so as to form a linear brush or a disk brush, the steel channel wall is pressed to project and form a latching section to the inside of the channel, the latching section is pressed and latched to the solid portion of the steel brush wires, and a synthetic resin solidification agent is applied to the steel brush wires near the opening of the steel channel.

Claim 19: A method of manufacturing a brush wherein a necessary number of synthetic resin fibers for a brush of a predetermined length are aligned, a fixed number of the synthetic resin fibers for a brush are conveyed to a fusion-bonding process portion, the root portions of the aligned fibers are fusion-bonded and are then inserted into an opening of a separately supplied synthetic resin channel, the root portions are heated and pressed from the outside of the synthetic resin channel to fix the root portions and the channel for forming a brush material, and the brush material is used to form a linear brush material, a spiral brush material, or an annular brush material which is then fixed into a shaft.

Claim 20: A method of manufacturing a brush wherein a necessary number of wires for a brush of a predetermined length are aligned, a synthetic resin channel is fitted to end portions of the wires for a brush, the synthetic resin channel is heated and pressed from its outside to fix the wires and the synthetic resin channel for forming a brush material, and the brush material is used to form a linear brush material, a spiral brush material, or an annular brush material which is then fixed into a shaft or a fixing plate.

Claim 21: The method of manufacturing a brush according to claim 19, wherein the synthetic resin is a heat-resistant thermoplastic synthetic resin such as polyamide, polypropylene, polycarbonate, polyvinyl alcohol, or polyvinyl butyral.

Claim 22: The method of manufacturing a brush according to claim 19, wherein the fixing is performed by fusion-bonding by beating and pressing.

Claim 23: The method of manufacturing a brush according to claim 19, wherein the annular shape is circular, elliptical, or polygonal.

In the above, any synthetic resin fiber having heat resistance, abrasion resistance, and toughness can be used.

The wire is referred to as a stainless steel wire, a hard metal wire, and other metal wires.

The heating temperature in the above is different according to the kind of the synthetic resin. The temperature of a heating plate is more than 600° C. The heating and melting time is considered so as to enable channel fusion-bonding of 3 to 4 m per minute which is different according to the kind of the synthetic resin and the diameter of the fiber. To promote solidification, a die needs to be cooled to 50 to 60° C. to shorten the process time and be thermally deformed.

The diameter of the synthetic resin fiber used in the present invention is 0.01 to about 5 mm. The length thereof is different according to use of the brush and is 30 to about 500 mm.

In the above, the solidification time can be shortened by water cooling (5 to 10° C.) after heating and melting.

The fixing is performed by fusion-bonding by heating and pressing. The annular shape is circular, elliptical or polygonal.

In the invention, a synthetic resin solidification agent is applied to near the steel channel of the brush material. Folding-damage and falling-off of the wire brush wires from the portion can be prevented.

The projection end of the latching section formed in the steel channel is latched to the synthetic resin solid portion of the steel wires. When a force to move the steel brush wires to the outside of the steel channel acts, the latching section is operated so as to be pierced into the solid portion. The solid portion of the steel brush wires cannot fall off the steel channel. The falling-off can be prevented.

The synthetic resin solidification agent is applied to and penetrated into near the portion of the steel wires abutting the channel. Local concentration of a deforming force onto the portion can be prevented. Loosening or folding-damage of the steel wires can be prevented.

In the invention, with the use of the synthetic resin brush wires, in order to solidify their end portions, the molten synthetic resin is applied or the synthetic resin wires are heated and melted to form the solid portion. When the synthetic resin channel is used, it is heated to integrally bond the synthetic resin channel and the synthetic resin wires.

The synthetic resin in the above includes polyamide, polypropylene, polycarbonate, polyvinyl alcohol, or silicone resin, and need to have toughness and weatherability.

A silicon sealant is used as the synthetic resin solidification agent. The application portions of the steel brush wires are an elastic solid portion.

In the present invention, with the synthetic resin totally used, the root portions of an appropriate number of synthetic resin fibers are fusion-bonded and solidified, and the solidified portion is inserted into the synthetic resin channel and is then sandwiched and fixed by the channel wall so as to be formed in linear, spiral, or annular shape, thereby obtaining one or a plurality of linear, spiral, or annular brush materials. The brush material or the brush materials are fitted and fixed into the shaft. A roll brush or a brush plate can be easily manufactured.

The total material is synthetic resin. A disposal brush can be integrally recycled as a process of an old synthetic resin material. For recycling, a troublesome sorting work such as separation according to type is unnecessary.

The fibers and the channel are fixed by heating and melting. The workability is good. All of the brush material can be homogeneously and reliably manufactured only by temperature control.

According to the present invention, the brush density can be easily changed. The degree of freedom can be very high. The brush density has been restricted according to channel count in the prior art. In the fusion-bonded brush of the present invention, a necessary amount of raw material which meets the purpose of use of the brush can be fusion-bonded without some restrictions of the raw material. The density can be adjusted very easily. The coarseness and fitness of the spiral brush has been determined according to pitch. In the present invention, the coarseness and fineness is determined by the number of fibers. The concept of the pitch of the brush material is almost unnecessary. The coarseness and fineness of the ring brush has been determined according to the length and the number of spacers. In the present invention, the coarseness and fineness is determined according to the number of fibers, needing no spacers.

In the present invention, the synthetic resin is applied to and penetrated into the root portions of the steel wires and is then solidified. The portion becomes strong as if it were a synthetic resin lump including reinforcing steel and becomes an integrally continuous solid portion. The solid portion is sandwiched and fixed into the steel channel to prevent loosening and falling-off of the steel wires. The root portions of the synthetic resin brush wires are formed with the solidification portion by the synthetic resin adhesive or heating and fusion-bonding and can be integrated with the channel.

The latching section of the steel channel is abutted on and latched to the continuous solid (when a falling-off force is applied to the steel wires, the latching section is engaged more and more) to prevent loosening or falling-off of the solid portion.

The latching section is provided throughout the circumference of the ring-like channel or the length of the linear channel. The solid portion of the steel wires is stably and uniformly fixed and is sandwiched and fixed at the same strength throughout the circumference, causing no local strength and weakness. The opening of the channel is formed so as to be curved outward. If the steel wires receive an external force and is then strongly abutted on the opening of the channel, the abutting force is distributed and supported by the curving portion to prevent folding-damage of the wires.

The synthetic resin solidification agent is applied to the steel brush wires. If a vibration stress is repeatedly applied to near the root portions of the wires, local concentration of the stress, loosening or folding-damage of the steel brush wires, and scattering of the folding-damaged wires can be prevented.

The present invention can provide a linear or disk brush material and a cylindrical brush which can be widely used for a brush for cleaning or general use driven by power or a heavy work such as snow removal, water draining, or cleaning.

### BRIEF DESCRIPTION OF THE DRAWINGS

FIG. 1A is a cross-sectional view, with parts omitted, of an embodiment of a disk steel brush according to the present invention, and FIG. 1B is a perspective view, with parts omitted, of the disk steel brush illustrated in FIG. 1A;

FIG. 2A is a plan view, with parts omitted, explaining a state that steel brush wires are arranged to a predetermined thickness to provide a solid portion in their root portions, FIG. 2B is a side view, with parts omitted, of FIG. 1A, and FIG. 2C is an explanatory view explaining a state that a brush band is fitted into a steel channel;

FIG. 3A is a cross-sectional view, with parts omitted, of a disk brush according to the present invention, and FIG. 3B is a front view, with parts omitted, of a tubular brush according to the present invention;

FIG. 4A is a cross-sectional view, with parts omitted, of another embodiment of the disk steel brush according to the present invention, FIG. 4B is a perspective view, with parts omitted, of the disk steel brush illustrated in FIG. 4A, and FIG. 4C is a partially enlarged sectional view of another disk steel brush;

FIG. 5A is a cross-sectional view, with parts omitted, of a further embodiment of the disk steel brush according to the present invention, and FIG. 5B is a perspective view, with parts omitted, of the disk steel brush illustrated in FIG. 5A;

FIG. 6A is a plan view, with parts omitted explaining a state that brush wires are arranged to a predetermined thickness and formed at their root portions with a solid portion are fitted into a channel, FIG. 6B is a cross-sectional view, with parts omitted, of FIG. 6A, and FIG. 6C is a cross-sectional view, with parts omitted, of a further embodiment corresponding to FIG. 6B;

FIG. 7A is a front view, with parts omitted, of a still another embodiment of a brush according to the present invention, FIG. 7B is a cross-sectional view, with parts omitted, of FIG. 7A, and FIG. 7C is a partially sectional enlarged view of a brush wire fixing portion:

FIG. 8 is a block diagram explaining an example of a process of a manufacturing method according to the present invention:

FIG. 9 is a schematic diagram explaining an example of a brush material manufacturing process according to the present invention;

FIG. 10 is a plan view of a linear brush material according to the present invention;

FIG. 11A is a perspective view, with parts omitted, of an annular brush material according to the present invention, and FIG. 11B is a perspective view, with parts omitted, of a spiral brush material according to the present invention;

FIG. 12A is a side view of the annular brush according to the present invention, and FIG. 12B is a partially enlarged perspective view illustrating a stepped portion of the annular brush;

FIG. 13A is a partially sectional view of a plate-like brush according to the present invention, and FIG. 13B is a perspective view of a box-shaped brush according to the present invention;

FIG. 14 is a sectional enlarged view, with parts omitted, of a roll brush according to the present invention;

FIG. 15A is a cross-sectional view, with parts omitted, explaining a state that a brush tube is fixed according to the present invention, FIG. 15B is a left side view which omits a retaining plate, FIG. 15C is a left side view which omits a mounting plate, and FIG. 15D is a partially sectional enlarged view;

FIG. 16A is a right side view of an embodiment of a disk used for fixing the brush tube according to the present invention, FIG. 16B is a side view of an outer tooth disk, FIG. 16C is a side view of the retaining plate, and FIG. 16D is a side view of an inner tooth disk;

FIG. 17A is a partially sectional view of another embodiment used for fixing the brush tube according to the present invention. FIG. 17B is a side view, FIG. 17C is a sectional enlarged view illustrating fixing of a projection, and FIG. 17D is a side view of a mounting plate, and

FIG. 18 is an enlarged sectional view, with parts omitted, illustrating fiber fixation according to a related art brush.

### DESCRIPTION OF THE PREFERRED EMBODIMENTS

In the present invention, synthetic resin fibers, e.g., polypropylene fibers are cut to a predetermined length and are then stacked to a predetermined thickness so as to be supplied. End portions thereof pass sideways of a heating plate and are then heated (e.g., 600° C.). The end portions of the synthetic resin fibers fed on a conveyer are fusion-bonded and solidified at 3 to about 4 m per minute.

The solidification portion of the synthetic resin fibers are inserted into a synthetic resin channel supplied at a constant speed. Opening side walls of a channel prototype corresponding to the synthetic resin channel which has just been discharged from an extruder and still has heat are sandwiched by a pressing plate from outside. The synthetic resin channel and the solidification portion of the synthetic resin fibers are fusion-bonded and integrated. A die is molded to uniformly manufacture brush materials in the following shapes.

The synthetic resin channel fusion-bonded to the fibers is made circular to obtain an annular brush material. When a plurality of spiral portions of the synthetic resin channels are overlapped with each other and fixed, a tubular body brush material is made. When several synthetic resin channels are overlapped with each other in linear state and fixed, a box-shaped brush material is made.

When the tubular body brush material is fitted and fixed into a brush shaft, a roll brush is made. When the annular brush material is fitted and fixed into one end of a shaft, a plate-like brush is made.

In a disk steel brush material according to the present invention, the root portions of a large number of steel brush wires are solidified by synthetic resin to obtain a solid portion, the solid portion is radially fitted into a ring-like steel channel having a U-shaped cross section and an opening directed to an outer peripheral side, the side wall of the steel channel is pressed to project a latching section into the steel channel and is then pressed and latched to the solid portion of the solidified steel brush material for integrating the steel channel and the steel brush wires. A synthetic resin solidification agent is applied to and penetrated into the steel brush wires near the steel channel. In the above, the size and number which have been used can be used as the material, diameter, length, and number of the steel brush wires. The material, diameter, length, and number used of the steel brush wires can be selected according to application.

As the synthetic resin for fixing the root portions of the steel brush wires, any thermoplastic synthetic resin (e.g., polypropylene, ABS resin, PTFE resin, and acrylic resin) which has an affinity to the steel brush wires, toughness, durability and weatherability can be used.

When a plurality of disk steel brush materials are fitted and fixed into a rotating shaft, a tubular rotary brush is made. When a linear steel channel is used in place of the ring-like steel channel, a linear steel brush material is made.

To solidify the root portions of the steel brush wires and fit and fix them into the steel channel, the steel brush wires cut to a predetermined length are arranged and stacked to a thickness corresponding to an opening width of the steel channel. The molten synthetic resin is extruded and applied to the root portion side of the steel brush wires, and is then penetrated and cooled to obtain a steel brush band as an integral synthetic resin solid portion. The solid portion side of the steel brush band is fitted sequentially into the ring-like steel channel. The side recall of the steel channel is pressed to the solid portion side of the steel brush to form the latching section. The latching section end is pressed and latched to the solid portion.

The synthetic resin solidification agent (e.g., silicon sealant) is applied to and penetrated into the steel brush wires near the steel channel to complete the disk steel brush material according to the present invention. The material, diameter, length, and number of the steel brush wires are appropriately selected according to application.

The opening of the steel channel is formed so as to be curved outward to facilitate insertion of the solid portion of the steel brush. Upon contact due to deformation of the steel brush wires during use of the brush, a stress is not locally concentrated to prevent the folding-damage. The synthetic resin solidification agent can prevents separation of the steel brush wires. The scattering of folding-damaged wires can be prevented.

### Embodiment 1

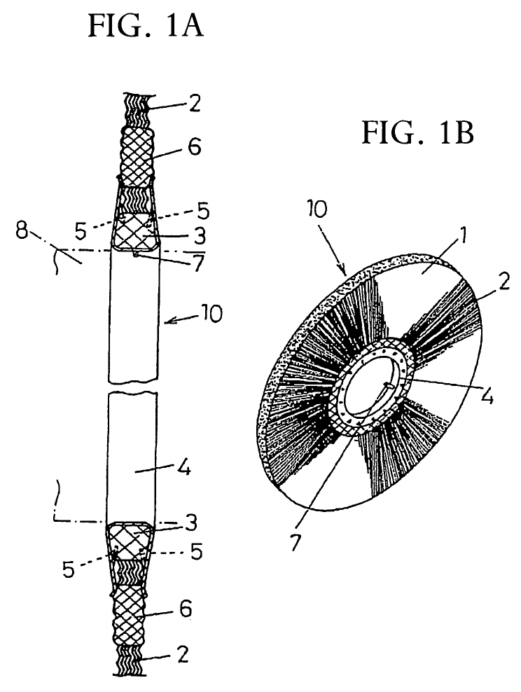

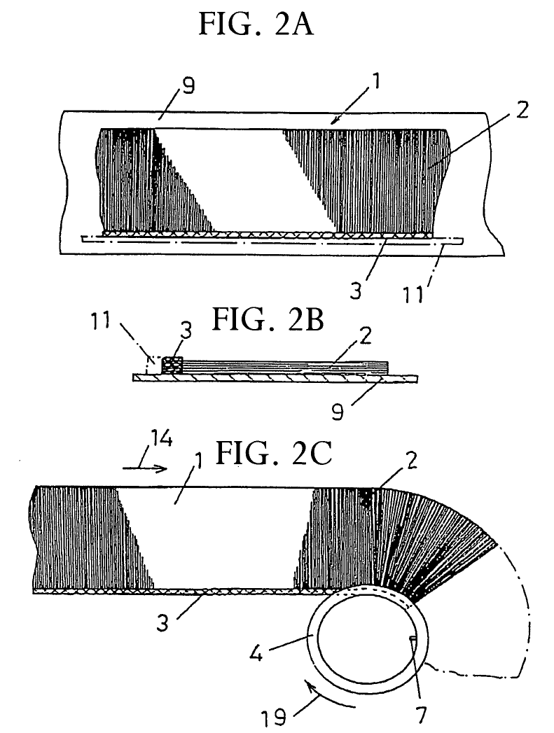

An embodiment of the present invention will be described with reference to FIGS. 1A, 1B, and 2A to 2C.

A large number of steel brush wires 2 and 2 molded in wavy shape are linearly arranged to a predetermined thickness (FIG. 2A). Polypropylene is applied to and penetrated into the root portion side of the steel brush wires 2 and 2. The root portion side of the steel brush wires 2 and 2 are cooled and solidified to obtain a solid portion 3. A steel brush band 1 is thus formed (FIG. 2A).

The solid portion 3 of the steel brush band 1 is fitted into the outer peripheral portion (U-shaped portion) of a ring-like steel channel 4 which is separately manufactured and has a U-shaped cross section. The side wall of the steel channel 4 is pressed to form a latching section 5 inwardly of the steel channel 4. The edge of the latching section 5 is pressed and latched to the solid portion 3 of the steel brush band 1 (FIG. 1A).

A silicon sealant 6 is applied to and penetrated into the steel brush wires 2 and 2 near the outer peripheral portions of the steel channel 4. A disk steel brush material 10 according to the present invention is thus made. In FIGS. 1A and 1B, a key 7 is latched to a rotating shaft 8.

As illustrated in FIG. 1A, the U-shaped cross section portion of the steel channel 4 which fits the steel brush wires 2 thereinto has both opening edge portions curved outward. In other words, both side walls on the opening side are opened in convex shape in a cross section. Even if the steel brush wires 2 are severely vibrated, the steel brush wires 2 and the steel channel 4 are brought into contact with each other in the convex arcuate portion. The steel brush wires 2 cannot be excessively bent.

Even if the steel brush wires 2 are severely vibrated, they are supported on a curved surface without being supported on a local supporting point. Occurrence of metal fatigue and other folding-damage can be controlled. In other words, the steel brush wires 2 are deformed within an elastic limit. Folding-damage and permanent deformation cannot be caused.

The solid portion 3 of the steel brush wires 2 is fitted into the steel channel 4 which has a U-shaped cross section and an opening directed to an outer peripheral side and is latched by the latching section 5. The steel brush wires 2 to which a centrifugal force is applied cannot fall off.

The centrifugal force is applied more largely to the end portions of the steel brush wires 2. The solid portion 3 is latched by the latching section 5. When the solid portion 3 receives the centrifugal force and attempts to jump out, the latching section 5 is latched to the solid portion 3 in a direction latching it more strongly. Unless the steel brush wires 2 are cut, the steel brush wires 2 cannot fall off the steel channel 4.

The synthetic resin solidification agent such as the silicon sealant 6 is applied to and penetrated into the steel brush wires 2 and 2 near the outer peripheral portions of the steel channel 4. Movement (vibration) of the steel brush wires 2 is thus appropriately controlled. The steel brush wires 2 are hardly moved (vibrated) due to brushing work. No excessive force can be locally applied to the portion. The steel brush wires 2 fitted into the steel channel 4 cannot be loosened, folding-damaged, or broken near the steel channel 4. If the steel brush wires 2 are folding-damaged, they are held by the portion to prevent scattering.

### Embodiment 2

A method of manufacturing the disk steel brush material 10 according to the present invention illustrated in FIG. 1B will be described with reference to FIGS. 1A, 1B, and 2A to 2C.

The steel brush wires 2 cut to a predetermined length are stacked on a base plate 9 (or conveyer) to a predetermined thickness. The ends of the steel brush wires 2 are arranged by the base plate 9 and a guide plate 11 to make the thickness fixed.

Propylene resin is extruded and applied to the root portion side of the steel brush wires 2 (glide plate 11 side) over a predetermined width (e.g., 3 to 5 cm). The propylene resin is penetrated into the steel brush wires 2 and is then cooled and solidified to form the solid portion 3. When the polypropylene resin is sufficiently penetrated, in appearance, the root portion ends of the steel brush wires 2 are buried into the solid synthetic resin. In other words, in appearance, the root portion ends of the steel brush wires 2 are buried into the solid portion of the synthetic resin.

The solid portion 3 is formed in a predetermined number of the root end portions of the steel brush wires 2 to obtain the steel brush band 1.

The ring-like steel channel 4 which is separately manufactured is supported by a temporary shaft. The ring-like steel channel 4 has a U-shaped cross section and an opening directed to an outer peripheral side. As illustrated in FIG. 2C, one end of the steel brush band 1 is inserted into the steel channel 4, as indicated by an arrow 14. The steel channel 4 is rotated in a direction indicated by an arrow 19. The steel brush band 1 is easily fitted and set into the steel channel 4. In the above, the length of the steel brush band 1 set into the steel channel 4 (the length in a sidewise direction in FIG. 2A) is determined and can be cut beforehand.

As described above, when the steel brush band 1 is set into the steel channel 4, the outer side wall of the steel channel 4 is pressed to project the latching section 5 (FIG. 1A) and the latching section 5 and the solid portion 3 of the steel brush band 1 are pressed and latched. The silicon sealant 6 is applied to and penetrated into the nearby steel brush band 1 fitted into the steel channel 4. The disk steel brush material 10 (FIG. 1B) according to the present invention is thus made.

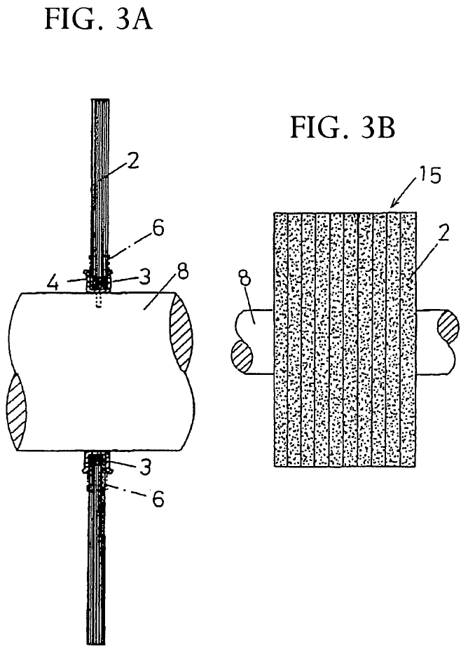

When the disk steel brush material 10 or a predetermined number of the disk steel brush materials 10 are fitted and fixed into the rotating shaft 8 (FIGS. 3A and 3B), a tubular rotary brush 15 according to the present invention is made. A plurality of the disk steel brush materials 10 contacted with each other are fixed into the rotating shaft 8 or the steel brush materials 10 are fixed at predetermined intervals. Brushes having different appearances can be manufactured according to application.

### Embodiment 3

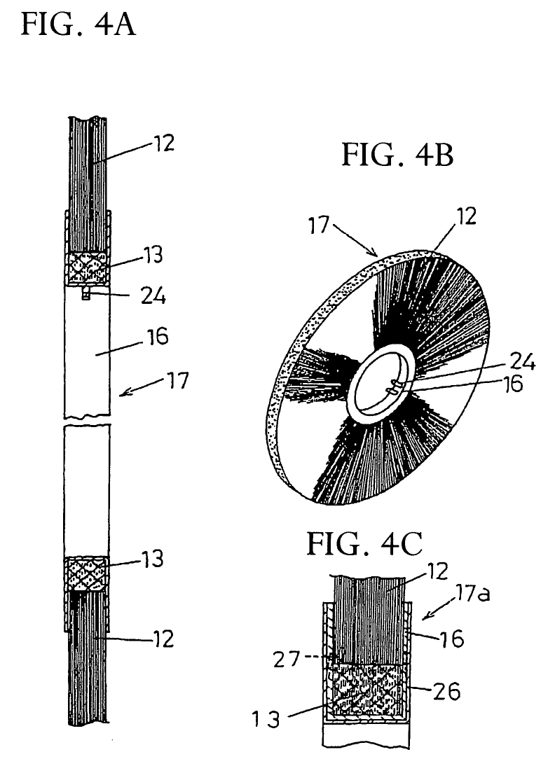

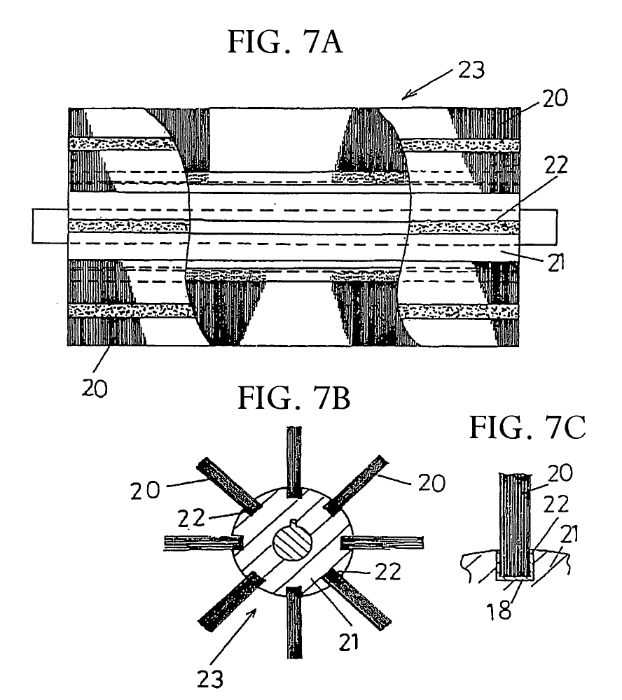

An embodiment according to the present invention will be described with reference to FIGS. 4A to 4C and 7A to 7C.

A solid portion 13 at ends of synthetic resin wires for a brush 12 is inserted into a ring-like synthetic resin channel 16 having a U-shaped cross section and an opening directed to an outer peripheral side. The synthetic resin channel 16 is pressed to and integrated with the solid portion 13 of the synthetic resin wires for a brush 12 to obtain a disk brush material 17.

For pressing, the solid portion 13 of the synthetic resin wires for a brush 12 and the synthetic resin channel 16 can be fusion-bonded, fixed, and integrated by heating them to near the melting point or the synthetic resin channel 16. In FIGS. 4A and 4B, a key 24 is latched to a rotating shaft.

When a linear synthetic resin channel 18 (FIG. 7C) is used, a linear brush material 20 can be obtained. As illustrated in FIG. 7B, a plurality of fitting grooves 22 are provided in the outer peripheral portion of a rotating shaft 21 so as to be parallel with the centerline of the rotating shaft 21. When the linear brush materials 20 are fitted and fixed into the fitting grooves 22, a tubular rotary brush 23 can be obtained.

The solid portion 13 at ends of the synthetic resin wires for a brush 12 is integrated with the synthetic resin channel 16 or the synthetic resin channel 18. The solid portion 13 and the synthetic resin channels 16 and 18 are easily integrated. The synthetic resin wires for a brush 12 cannot fall off the synthetic resin channels 16 and 18. Therefore, the brush can be used at the same efficiency for a long time.

As illustrated in FIG. 4C, a steel channel 26 is fitted to the outside of the synthetic resin channel 16, and a latching section 27 is provided on the side wall of the steel channel 26 and presses and is latched to the synthetic resin channel 16. The synthetic resin channel 16 and the steel channel 26 are integrally fixed to obtain a brush material 17a which can bear a heavy work. The steel channel 26 can be fixed by facing two steel channels having an L-shaped cross section.

### Embodiment 4

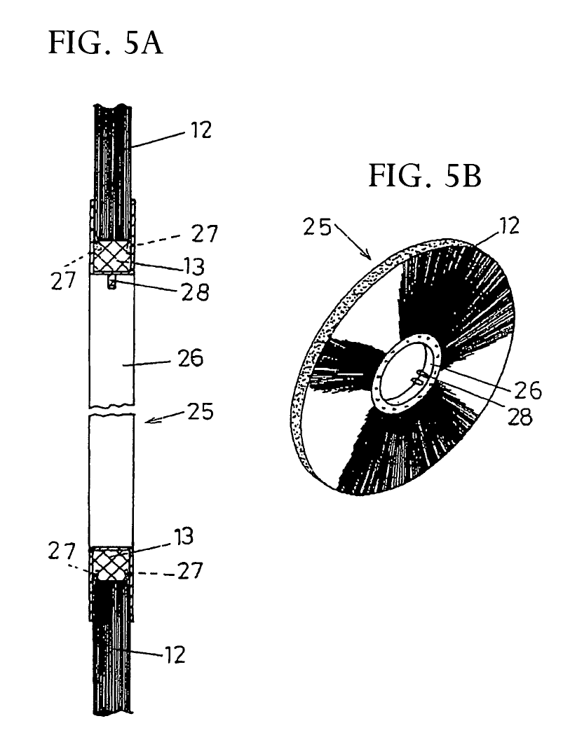

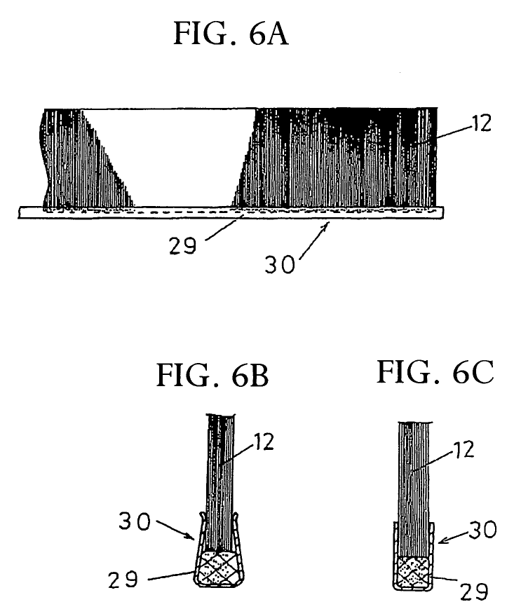

An embodiment according to the present invention will be described with reference to FIGS. 5A, 5B, and 6A to 6C.

The solid portion 13 of the synthetic resin wires for a brush 12 is inserted into the ring-like steel channel 26 having a U-shaped cross section and an opening directed to an outer peripheral side. The side wall of the steel channel 26 is pressed to cut out the latching section 27. The latching section 27 is latched to the solid portion 13 to obtain a disk brush material 25. In FIGS. 5A and 5B, a key 28 is latched to a rotating shaft.

As illustrated in FIGS. 6A to 6C, when a linear channel 29 is used in place of the ring-like steel channel 26, a linear brush material 30 is made.

### Embodiment 5

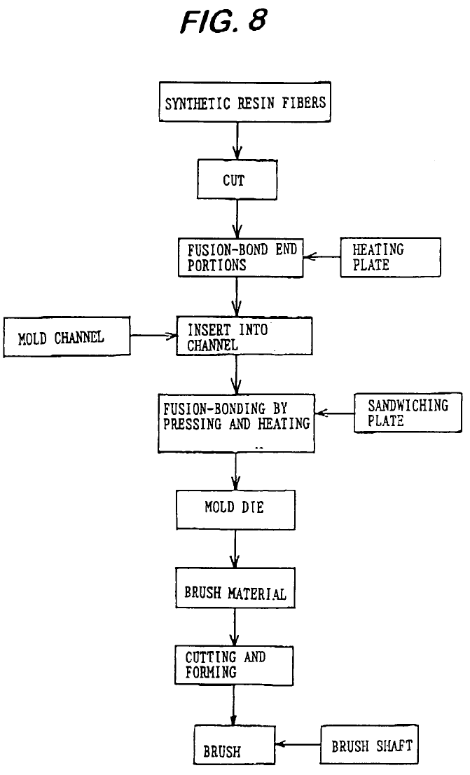

A manufacturing method according to the present invention will be described with reference to FIG. 8.

Polypropylene fibers having a thickness of 0.1 mm and a length of 40 mm are stacked in band shape having a thickness of 3 mm. One side of the polypropylene fibers passes sideways of the heating plate and end portions on one side are heated (e.g., 600° C.). The ends on one side of the polypropylene fibers are fusion-bonded at a speed of 3 to about 4 m per minute.

The fusion-bonding portion of the polypropylene fibers is inserted into an opening of a polypropylene channel having a U-shaped cross section. The polypropylene channel is sandwiched by a sandwiching plate and is then heated to 700° C. The polypropylene fibers and the polypropylene channel are fusion-bonded and fixed to make the brush material according to the present invention.

The brush material is formed in annular shape to form one or a plurality of annular brush materials so as to be fitted and fixed into a shaft. Alternatively, the brush material is spiral-shaped and is then fitted and fixed into the shaft. The roll brush or the disk brush according to the present invention is made.

### Embodiment 6

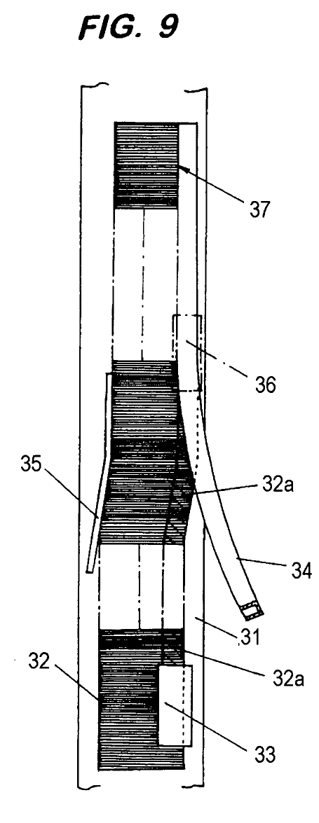

An embodiment according to the present invention will be described with reference to FIGS. 9, 10, 11A, 11B, 12A, 12B, 13A, 13B, and 14.

Polypropylene fibers 32 having a thickness of 0.1 mm and a length of 40 mm are stacked on a traveling conveyer 31 to a thickness of 3 mm. A sandwiching plate 33 is pressed onto sides (root portions) of the stacked polypropylene fibers 32. The portions are heated to 800° C. and fusion-bonded to form a fusion-bonding portion 32a. Alternatively, in place of fusion-bonding, the root portions are held in alignment.

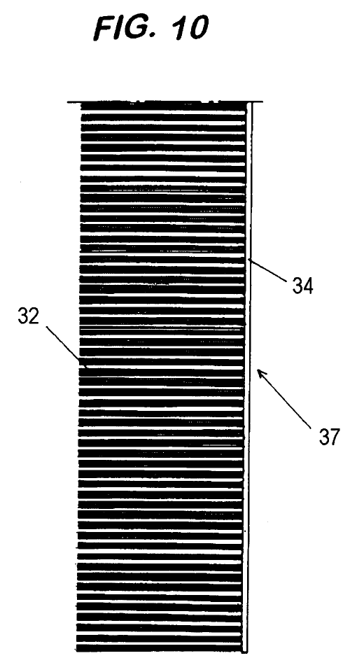

An extruded and molded synthetic resin channel 34 is supplied. The synthetic resin channel 34 has a U-shaped cross section and an opening directed to an outer periphery. A fusion-bonding portion 32a of the polypropylene fibers 32 is pressed into the synthetic resin channel 34 by using a guide plate 35. The synthetic resin channel 34 is pressed by a pressing plate 36 to integrally fusion-bond the polypropylene fibers 32 and the synthetic resin channel 34 for forming a brush material 37 illustrated in FIG. 10.

In the above, the thickness and length of the polypropylene fibers 32 are determined according to application. As described above, a brush having relatively thin fibers is used for indoor cleaning.

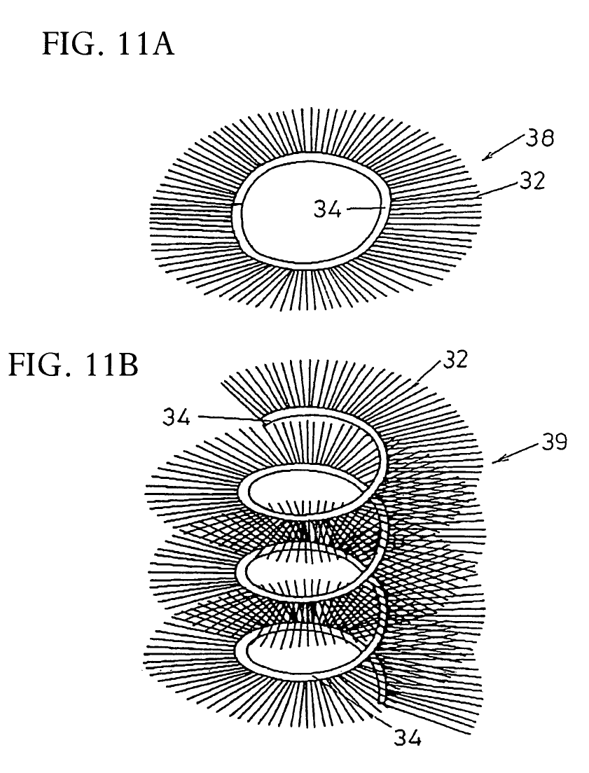

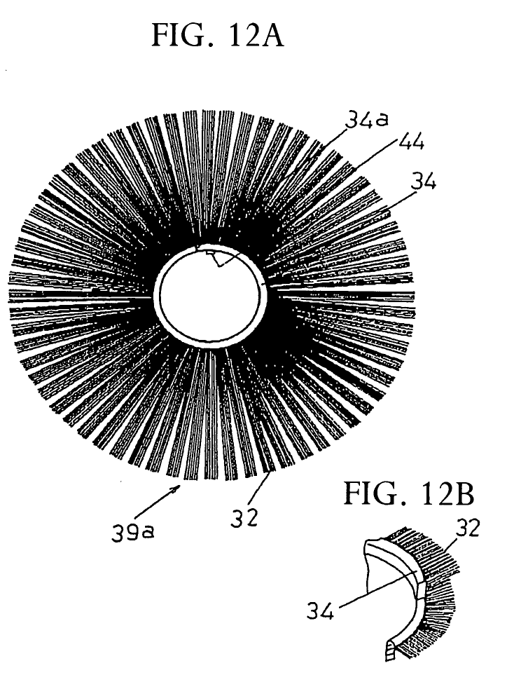

The brush material 37 is cut so as to be relatively short to obtain an annular brush 38 (FIG. 11A). Alternatively, the brush material 37 is cut so as to be long to obtain a spiral brush material 39 (FIG. 11B). The synthetic resin channels 34 are overlapped and fusion-bonded, thereby obtaining an annular brush 39a or obtaining a spiral brush as shown in FIG. 12A or 12B. In FIG. 12A, a key 44 is latched to a rotating shaft.

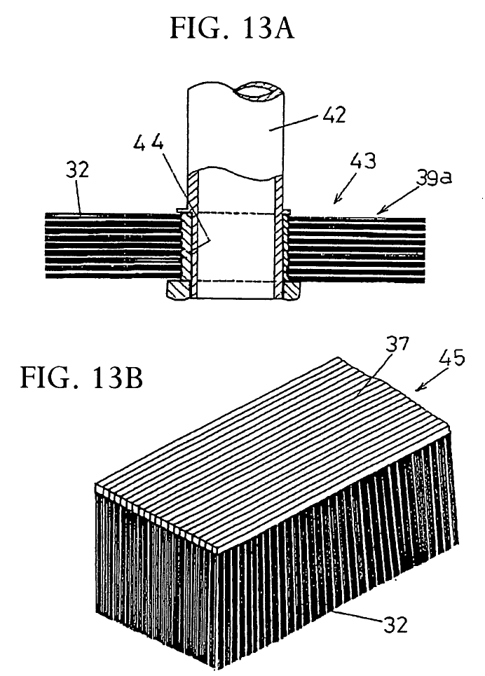

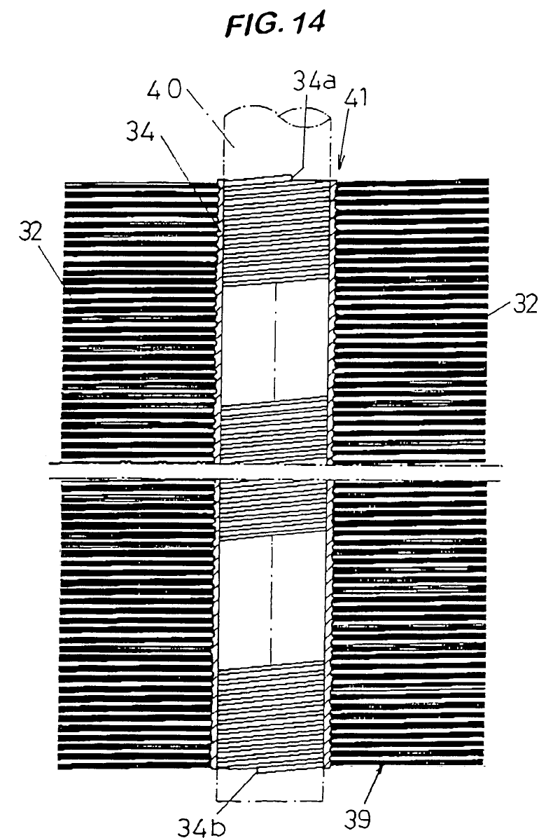

When the spiral brush 39 is fitted and fixed into a metal shaft 40, a roll brush 41 is made (FIG. 14). When the annular brush 39a is fitted and fixed into the end portion of the metal shaft 42, a plate-like brush 43 is made (FIG. 13A).

The brush material 37 is cut to a predetermined length. Some of the cut brush materials 37 are arranged in parallel to fusion-bond the channel portions of the brush materials 37. A box-shaped brush, that is, a rectangular parallelepiped brush 45 is made (FIG. 13B). The channel portions of the rectangular parallelepiped brush 45 are strong. A plate body is fixed to the channel portions. The end portion of a brush handle is attached to the plate body. In this way, a box-shaped brush with a handle which can be used by a user in standing state is made.

As described above, the length of the spiral brush 39 can be freely selected. The length of the roll brush having the same density throughout the length can be freely selected.

In the above description, the linear brush material is manufactured to manufacture the annular brush material or the spiral brush material.

When a die is used to bury end portions of fibers into the spiral channel, the spiral brush material is made. The spiral brush material is cut so as to be short as needed to fusion-bond the channel end. The annular brush material is thus made.

When any number of spiral brush materials are overlapped and thermally fusion-bonded to and integrated with an adjacent channel, a tubular brush material is thus made (FIG. 14). The brush is strongly fixed. The brush has the same strength as when the brush material directly is fixed to a tubular body.

In the above embodiments, the synthetic resin fiber is used. In place of the fibers, metal wires (the material of the metal is selected according to application) can be used.

### Embodiment 7

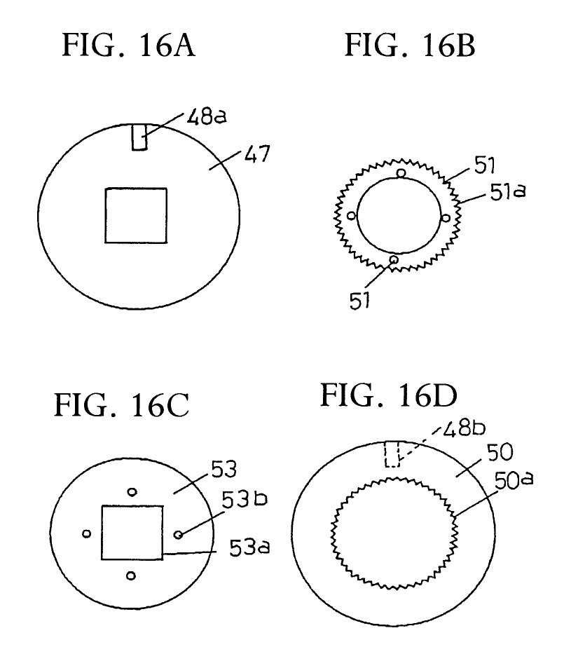

An embodiment according to the present invention will be described with reference to FIGS. 12A, 12B, 14, 15A to 15D, and 16A to 16D.

As illustrated in FIGS. 9, 10, 11A, and 11B, in the brush according to the present invention, ends of a large number of the polypropylene fibers 32 are abutted on and bonded to the synthetic resin channel 34.

When the synthetic resin channels 34 are helically wound in tubular shape and are then bonded to each other, the roll brush 41 is made (FIG. 14).

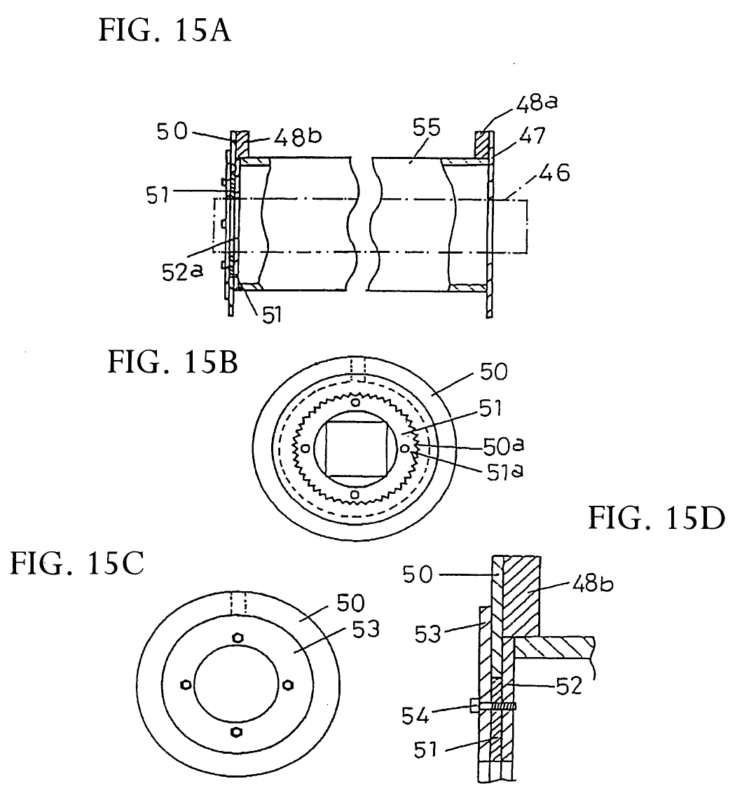

The cutting portions (right and left last ends) of the synthetic resin channel of the roll brush 41 become stepped portions 34a and 34b (upper and lower sides of FIG. 14). Projections 48a and 48b of disks 47 and 50 fixed to the rotating shall 40 are abutted on the stepped portions 34a and 34b (FIG. 15A). The roll brush 41 can be engaged with a rotating shaft 46 in a rotating direction.

In the above, the stepped portion 34a of one end portion of the roll brush 41 can rotate the disk 47 (the rotating shaft 46) to abut the stepped portion 34a and the projection 48a. On the other hand, the stepped portion 34b of the other end portion of the roll brush 41 cannot rotate the rotating shaft 46 (when one end portion of the roll brush 41 is fixed, the position of the stepped portion 34b of the other end portion is defined). The degree of freedom of positioning is lost.

The projection 48b of the inner tooth disk 50 which fixes the projection 48b and the stepped portion 34b are freely rotated to the position in which they abut so as to be abutted. An outer tooth 51a of an outer tooth disk 51 fixed to the rotating shaft 46 is engaged with an inner tooth 50a of the inner tooth disk 50. The rotating shaft 46 and the inner tooth disk 50 are confined in a rotating direction by engagement of the inner tooth 50a and the outer tooth 51a. A mounting plate 52 is fixed to the rotating shaft 46 (e.g., fixing by weld). The inner tooth disk 50 abuts the mounting plate 52 to engage an outer tooth disk 51 with the inner tooth disk 50 so that a retaining disk 53 abuts the outside thereof. When the retaining disk 53, the outer tooth disk 51, and the mounting plate 52 are integrally fixed by a bolt 54, the rotating shaft 46 can be confined in a rotating direction with the inner tooth disk 50 via the outer tooth disk 51. The rotating force of the rotating shaft 46 is transmitted to the brush via the outer tooth disk 51, the inner tooth disk 50, the projections 48a and 48b, and the synthetic resin channel 34.

In the above, the stepped portion 34a of the brush and the projection 48a can be easily abutted (the rotating shaft may be rotated until they abut). The abutment of the projection 48b and the stepped portion 34b of the brush is difficult because depending on the position of the stepped portion 34b, fundamentally, the rotating shaft 46 cannot be freely rotated due to the abutment of the stepped portion 34a and the projection 48a. As described above, the inner tooth disk 50 is rotated to abut the stepped portion 34b and the projection 48b, and then, the inner tooth disk 50 and the outer tooth disk 51 are engaged with each other to fix the outer tooth disk 51 to the mounting plate 52. The inner tooth disk 50 and the rotating shaft 46 can thus be fixed. The retaining plate 53 is confined in a rotating direction with the rotating shaft 46 since a square hole 53a is fitted into the rotating shaft 46 (square shaft).

Both the mounting plate 52 and the rotating shaft 46 can be confined in a rotating direction when the mounting plate 52 is fixed (welded) to a cylindrical shaft 55 to fit the square tubular portion of the rotating shaft 46 into a square hole 52a in the center portion of the mounting plate 52.

The bolt 54 is threaded to the outer tooth disk 51 and the mounting plate 52 to fasten and fix the retaining plate 53. In the above, when bolt holes 51b and 53b are opened at fixation, the retaining plate 53 can be easily fixed without being limited by position relation. When the center portion of the retaining plate 53 does not have a square hole, the rotating shaft 46 and the retaining plate 53 are not confined. The degree of freedom is higher.

### Embodiment 8

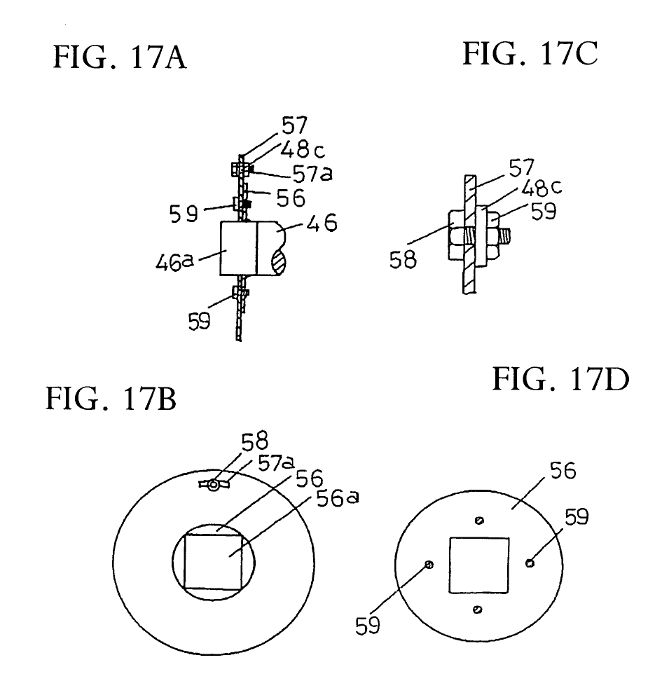

An embodiment according to the present invention will be described with reference to FIGS. 17A to 17D.

A mounting plate 56 is fitted and fixed into a square tubular portion 46a at the end of the rotating shaft 46 (fixing by welding). The rotating force is transmitted by a square tubular portion 46a and the square hole 56a of the mounting plate 56. The mounting plate 56 is fixed to the rotating shaft by welding.

A projection 48c which abuts the stepped portion 34b of the brush tube is fastened and fixed through a mounting hole 57a of a disk 57 by a bolt 58 and a nut 59. The mounting hole 57a is a concentric slot to finely adjust the fastening position of the bolt 58.

The disk 57 and the mounting plate 56 are fixed by screw bolts 59 and 59. The positions of the screw holes of the screw bolts 59 and 59 are determined after the positions of the brush lube and the stepped portion are determined. The displacement can be determined within the slot range of the mounting hole 57a.

Although the preferred embodiment of the present invention has been described so far by referring to the accompanying drawings, various altercation, modifications, and changes may be made to the embodiment described above without departing from the scope and spirit of the invention as defined in the claims and equivalents thereof.

1-23. (canceled)

24. A linear or disk steel brush material for a rotary brush, comprising:
a plurality of steel brush wires, including root portions that are fixed by synthetic resin to obtain a solid portion;
a linear or ring like steel channel having a U-shaped cross-section, an opening directed to an outer peripheral side and having opening edge portions that are curved outward and a latching section projecting inward from a steel channel wall wherein the solid portion is fitted into the steel channel and is then latched and fixed to the latching section.

25. The linear disk or steel brush material of claim 1 further comprising:
a sealing portion formed from a synthetic resin solidification agent applied where the plurality of steel brushes are inserted into the opening of the linear or ring-like steel channel.

26. A linear or disk brush material, comprising:
a plurality of synthetic resin wires including insertion portions which are solidified together by an adhesive or heating and fusion-bonding to form a solid portion;
a linear or ring-like synthetic resin channel having a U-shaped cross-section wherein the solid portion of the plurality of synthetic resin wires are inserted and fixed into the linear or ring-like synthetic resin channel so as to integrate the synthetic resin channel and the insertion portions of the synthetic resin wires.

27. A linear or disk brush material, comprising
a plurality of synthetic resin wires including insertion portions that are solidified by an adhesive or heating and fusion bonding to form a solid portion; and
linear ring-like steel channels having a U-shaped cross-section and a latching section formed by pressing and stamping a side portion of the steel channel wherein the solid portion of the synthetic resin wires is inserted into the linear or ring-like steel channel and the latching section is pressed and latched to the solid portion.

28. The linear or disk brush material of claim 26, wherein a steel channel is fitted to the outside of the synthetic resin channel and both channels are made integral.

29. The linear or disk brush material of claim 28, wherein a latching section is projected on a sidewall of the steel channel and is pressed and latched to the synthetic resin channel to make both channels integral.

30. The linear or disk brush material of claim 26, wherein a fixed number of insertion portions of the plurality of synthetic resin wires are continuously or intermittently inserted into the synthetic resin channel and are then fixed thereto.

31. The linear or disk brush material according to claim 30, wherein the plurality of synthetic resin wires are formed in a linear, spiral, or annular shape and are then fixed into a shaft.

32. The linear or disk brush material according to claim 31, wherein a predetermined number of the plurality of synthetic resin wires are fitted and fixed into a rotatable shaft and are then integrated therewith to obtain a roll brush.

33. The brush according to claim 1, further comprising:
stepped portions formed on both sides of the roll brush; and
disks having projections, the disks being fitted to the rotatable shaft are abutted to confine the roll brush in a rotating direction.

34. A brush wherein one or a plurality of annular brush materials are fixed into one end portion of a shaft to obtain a disk brush.

35. A brush wherein a predetermined number of the linear brush materials formed according to claim 31 are arranged in parallel, bonded, and fixed so as to be in box shape.

36. A brush wherein a predetermined number of the linear brush materials formed according to claim 31 are manufactured so as to be linear or deformed.

37. A cylindrical steel brush wherein a plurality of the disk steel brush materials using the ring-like steel channel according to claim 24 are fitted into a rotatable shaft, and are abutted and fixed or are fixed at predetermined intervals.

38. A tubular steel brush wherein a plurality of the linear steel brush materials according to claim 24 are supported so as to be parallel with a rotatable shaft at equally spaced intervals on a concentric circumference about the rotatable shaft.

39. A cylindrical brush wherein a plurality of the disk brush materials according to claim 26 are fitted into a rotatable shaft, and are abutted and fixed or are fixed at predetermined intervals.

40. A tubular brush wherein a plurality of the linear brush materials according to claim 26 are supported so as to be parallel with a rotatable shaft at equally spaced intervals on a concentric circumference about the rotatable shaft.

41. A method of manufacturing a linear or disk steel brush material, comprising:
arranging a plurality of steel brush wires of the same length at a predetermined thickness;
applying a molten synthetic resin to penetrate into a root portion side of the steel brush wires;
cooling and solidifying the molten synthetic resin to provide a solid portion to obtain a steel brush wire band;
inserting and fixing the solid portion of the steel brush wire band into a linear or ring-like steel channel which opens outward to form a linear brush or disk brush;
pressing a steel channel wall to project therefrom a latching section to the inside of the channel, the latching section being pressed and latched to the solid portion of the steel brush wires; and
applying a synthetic resin solidification agent to the steel brush wires near the opening of the steel channel.

42. A method of manufacturing a brush, comprising:
aligning a plurality of synthetic resin fibers of a predetermined length;
conveying a fixed number of the plurality of synthetic resin fibers to be fusion-bonded;
fusion-bonding root portions of the aligned fibers;
inserting the fusion-bonded root portions into an opening of a synthetic resin channel;
heating and pressing the root portions from the outside of the synthetic resin channel to fix the root portions and the channel to form a linear brush material, a spiral brush material, or an annular brush material; and
fixing the brush material into a shaft.

43. A method of manufacturing a brush, comprising
aligning a plurality of wires of a predetermined length;
fitting a synthetic resin channel to end portions of the plurality of wires;
heating and pressing the synthetic resin channel from the outside to fix the plurality of wires and the synthetic resin channel to form a linear brush material, a spiral brush material or an annular brush material; and
fixing the brush material into a shaft or a fixing plate.

44. The method of manufacturing a brush according to claim 42, wherein the synthetic resin is a heat-resistant thermoplastic synthetic resin such as polyamide, polypropylene, polycarbonate, polyvinyl alcohol, or polyvinyl butyral.

45. The method of manufacturing a brush according to claim 42, wherein the fixing is performed by fusion-bonding by heating and pressing.

46. The method of manufacturing a brush according to claim 42, wherein the annular shape is circular, elliptical, or polygonal.
